(19) United States
(12) Patent Application Publication
(10) Pub. No.: US 2024/0206462 A1
(43) Pub. Date: Jun. 27, 2024

(54) ESSENTIAL OIL-BASED AGRICULTURAL COMPOSITION AND METHOD FOR CONTROLLING A PEST USING THE SAME

(71) Applicant: MOMENTIVE PERFORMANCE MATERIALS INC., Waterford, NY (US)

(72) Inventors: Fengqi HE, Waterford, NY (US); Yong LONG, Waterford, NY (US); Guangxing LI, Waterford, NY (US); Zhengya CAO, Waterford, NY (US); G.A. POLICELLO, Waterford, NY (US)

(21) Appl. No.: 18/287,043

(22) PCT Filed: Apr. 28, 2022
(86) PCT No.: PCT/CN2022/089792

§ 371 Date: Oct. 16, 2023

(30) Foreign Application Priority Data
Apr. 30, 2021 (CN) 202110478372.5

(51) Int. Cl. A01N 31/02; A01N 25/02; A01N 25/30; A01P 3/00

(52) U.S. Cl. CPC A01N 31/02; A01N 25/02; A01N 25/30; A01P 3/00

(57) ABSTRACT

The present invention relates to an essential oil-based agricultural composition and use of the same for controlling a pest. The essential oil-based agricultural composition comprises: (a) an essential oil component comprising at least one geraniol-based compound selected from the group consisting of geraniol, geraniol carboxylate or a combination thereof, (b) a hydroxyl and/or alkoxy functionalized polysiloxane; (c) a nonionic surfactant comprising at least one selected from a blocked or random polyoxyethylene/polyoxypropylene copolymer and a fatty alcohol alkoxylate; and (d) optionally, water. The essential oil-based agricultural composition has excellent stability and improved droplet adhesion, and can effectively control pests, especially fungal plant pathogen.

### FIELD OF THE INVENTION

The present invention relates to an agricultural composition, in particular to an essential oil-based agricultural composition useful for controlling a pest. The present invention also relates to a method for preparing the essential oil-based agricultural composition and use of the composition for controlling a pest.

### BACKGROUND OF THE INVENTION

Essential oils are particular aromatic substances extracted from plants. Generally, essential oils are obtained from flowers, leaves, stems, roots, barks, fruits, seeds, resins and other parts of plants, which may be extracted by distillation, pressing, enfleurage or solvent extraction. It is known that some plant essential oils have a certain synergistic effect on herbicides, insecticides or microbicides, and thus have found applications in pesticide adjuvants to a certain extent.

In recent years, an orange peel essential oil has received extensive attention. This essential oil has a high penetration rate, and can enhance the penetration of pesticides when used as an adjuvant at a low concentration, allowing the pesticides to be absorbed by plants as quickly as possible. Besides, the orange peel essential oil also has an insecticidal and microbicidal activities, especially strong ability to control insects. The main component of the orange peel essential oil is d-limonene, which has been registered as an insecticide in China for the control of tomato whitefly.

Essential oil-based pesticides or pesticide adjuvants are very environmentally friendly as compared to traditional pesticides or pesticide adjuvants. However, the essential oil-based pesticides or pesticide adjuvants have problems of low microbicidal activity, difficulty in formulating stable dispersions, insufficient adhesion to plants, and the like.

Therefore, it would be highly desirable to provide essential oil-based agricultural compositions which have improved microbicidal activity, stability, adhesion, and the like.

### SUMMARY OF THE INVENTION

In an aspect, the present invention provides an essential oil-based agricultural composition comprising:
(a) an essential oil component comprising at least one geraniol-based compound selected from geraniol, geraniol carboxylate or a combination thereof,
(b) a polysiloxane of general formula (I):

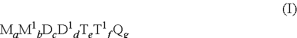

wherein
M=R¹R²R³SiO_{1/2}
M¹=R⁴R⁵R⁶SiO_{1/2}
D=R⁷R⁸SiO_{2/2}
D¹=R⁹R¹⁰SiO_{2/2}
T=R¹¹SiO_{3/2}
T¹=R¹²SiO_{3/2}
Q=SiO_{4/2}
in which
R¹, R², R³, R⁴, R⁵, R⁷, R⁸, R⁹ and R¹¹ each independently is selected from an alkyl group of 1 to about 6 carbon atoms and an aryl group of about 6 to about 14 carbon atoms,
R⁶, R¹⁰ and R¹² each independently is selected from a hydroxyl and an alkoxy group of 1-4 carbon atoms;
subscripts a and b each independently is from 0 to about 22, c and d each independently is from 0 to about 50, subscripts e, f and g each independently is from 0 to about 10, with the proviso that: a+b is about 2 to about 22; b+d+f is at least about 1, and e+f+g is up to about 10; and
(c) a nonionic surfactant comprising at least one selected from a blocked or random polyoxyethylene/polyoxypropylene copolymer and a fatty alcohol alkoxylate; and
(d) optionally, water.

The essential oil-based agricultural composition according to the present invention has an excellent stability and an improved droplet adhesion, and can effectively control pests, especially plant pathogen such as fungal plant pathogen and harmful insects such as whiteflies and aphids.

In another aspect, the present invention provides a method for preparing the agricultural composition, which comprises blending (a) the essential oil component, (b) the polysiloxane of general formula (I), and (c) the nonionic surfactant optionally in the presence of water. Typically, the composition of the present invention may be obtained in a form of a concentrate by blending the essential oil component (a), the polysiloxane (b) of the general formula (I) and the nonionic surfactant (c) in the presence of water which is in an amount of up to 50 parts by weight, for example 1-30 parts by weight, specifically 2-10 parts by weight relative to 100 parts by weight of the total weight of the components (a), (b) and (c). The composition in the concentrate form may be diluted, for example, with water, to a desired concentration, such as a concentration of 10 ppm to 1 wt % based on the amount of the geraniol-based compound before being applied to plants or soils. Notably, the essential oil-based agricultural compositions, whether in concentrate (even anhydrous) forms or diluted forms are encompassed within the scope of the present invention, as long as they comprise said components (a), (b) and (c).

In yet another aspect, the present invention provides a method for controlling a pest, which comprises applying the agricultural composition of the present invention to a soil or a plant. The essential oil-based agricultural composition according to the present invention is effective in controlling pests, especially plant pathogens such as fungal plant pathogens and harmful insects such as whiteflies and aphids.

The inventors of the present invention have unexpectedly found that geraniol or geraniol carboxylate has high inhibitory activities against some fungal plant pathogens, and thus can protect plants against diseases caused by these fungal plant pathogens. Therefore, a further aspect of the present invention relates to use of geraniol or geraniol carboxylate for protecting plants, especially crops. According to the present invention, geraniol or geraniol carboxylate can be used to control at least one fungal plant pathogen selected from genus of Botrytis, Passalora, Phytophthora and Corynespora; specifically Botrytis cinerea, Passalora fulva, Phytophthora infestans and Corynespora cassiicola, and more specifically Botrytis cinerea. Thus, geraniol or geraniol carboxylate can also be used to protect plants against diseases caused by said fungal plant pathogens, in particular grey mold, leaf mold, late blight and target spot diseases.

### BRIEF DESCRIPTION OF THE DRAWINGS

FIG. 1 is a graph illustrating the dynamic surface tension of the essential oil-based agricultural compositions from Example 1, Comparative Example 1, and Comparative Example 3.

### DESCRIPTION OF THE INVENTION

In the specification and claims herein, the following terms and expressions are to be understood as indicated.

The singular forms “a”, “an”, and “the” include the plural, unless the context clearly dictates otherwise.

It will be understood that any numerical range recited herein includes all sub-ranges within that range and any combination of the various endpoints of such ranges or sub-ranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

Other than in the working examples or where otherwise indicated, all numbers expressing amounts and quantified properties of materials, and operation conditions such as time durations, temperatures and pressure, and so forth, stated in the specification and claims are to be understood as being modified in all instances by the term “about”.

All method steps described herein may be performed in any suitable order unless otherwise indicated herein or otherwise clearly contradicted by context.

The use of illustrative or exemplary language (e.g., “such as”) provided herein, is intended merely to better illuminate the invention and does not pose a limitation on the scope of the invention unless otherwise claimed.

The terms, “comprising”, “including”, “containing”, and grammatical equivalents thereof are inclusive or open-ended terms that do not exclude additional, unrecited elements or method steps, but will also be understood to include the more restrictive terms “consisting essentially of”, “consisting of” and “composed of”.

The stoichiometric subscripts as used herein may be an average on a number basis or a mole basis, and thus can include fractions and integers.

The term “agricultural composition” as used herein refers to a composition that is applied to plants, weeds, landscapes, grass, trees, pastures, or for other agricultural applications. The agricultural composition may be provided in a concentrate form or a diluted form.

Herein, “essential oil-based composition” and “essential oil composition” may be used interchangeably to mean a composition comprising an essential oil.

The term “hydrocarbon group” means any hydrocarbon from which one or more hydrogen atoms has been removed and includes alkyl, alkenyl, alkynyl, cyclic alkyl, cyclic alkenyl, cyclic alkynyl, and aryl optionally containing at least one heteroatom.

The term “alkyl” means any monovalent, saturated, linear or branched hydrocarbon group. Specific examples of alkyl include but are not limited to methyl, ethyl, n-propyl, isopropyl, n-butyl, isobutyl, sec-butyl and tert-butyl.

The term “aryl” means any monovalent aromatic hydrocarbon group including alkylaryl and arylalkyl. Specific examples of aryl include but are not limited to phenyl, tolyl, benzyl, ethylphenyl and phenethyl.

In an aspect, the present invention provides an essential oil-based agricultural composition comprising at least (a) an essential oil component, (b) a polysiloxane, and (c) a nonionic surfactant. Optionally, the composition further comprises water and other ingredients used as needed.

### (a) Essential Oil Component

The essential oil component comprises at least one geraniol-based compound selected from geraniol, geraniol carboxylate or a combination thereof.

The term “essential oil” as used herein refers to aromatic substances that may be extracted from plants. However, such aromatic substances can also be synthesized artificially, and thus synthetic essential oils are also encompassed within the scope of the present invention.

Geraniol, also known as lemonol or 3,7-dimethylocta-2,6-dien-1-ol, has the following structural formula:

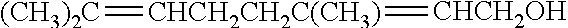

Geraniol is a acyclic monoterpene alcohol compound that is found in more than two hundred plant essential oils extracted from natural sources including geraniol oil, citronella oil, palmarosa oil, rose oil, lemongrass oil, lavender oil, and the like.

Geraniol may be, for example, in a highly pure form having a purity of at least 97%, such as 98% or higher. Geraniol may also be available, for example, in a mixture form of isomers as Geraniol 60, Geraniol 85 and Geraniol 95. Geraniol 60, Geraniol 85, or Geraniol 95 further contains nerol, which is the cis-isomer of geraniol and may be extracted from rose, neroli and lavender oils.

When referring to geraniol herein, it encompasses geraniol incorporated in any form, including in the form of a crude essential oil, in the form of a purified essential oil, in the form of a geraniol/nerol mixture, and in a highly pure form of geraniol.

Geraniol carboxylate refers to an ester formed from a mono-, di- or poly-carboxylic acid and geraniol. The number of carbon atoms of the carboxylic acid may be, for example, 1 to about 30, specifically 1 to about 20, and more specifically 1 to about 10. In an embodiment, the carboxylic acid is a monocarboxylic acid, specifically a monocarboxylic acid having 1 to about 10 carbon atoms, such as formic acid, acetic acid, propionic acid, butyric acid, isovaleric acid, and the like. In a preferred embodiment, the geraniol carboxylate is selected from geraniol formate and geraniol acetate.

Geraniol carboxylate may be extracted from natural materials. For example, geraniol formate may be extracted from geranium oil, labrador tea oil, and the like; geraniol acetate may be extracted from Sri Lankan citronella, palmarosa, orange leaf, rento, and the like; and geraniol isovalerate may be extracted from lemon eucalyptus oil.

Geraniol carboxylate may also be prepared from geraniol with the corresponding carboxylic acid or anhydride via esterification reaction well known in the art. For example, geraniol acetate may be prepared by subjecting acetic anhydride and geraniol to an esterification reaction in the presence of soda, optionally followed by neutralization, washing, drying and distillation.

The geraniol-based compound may be present in an amount from about 10 ppm to about 50 wt %, preferably from about 20 ppm to about 20 wt %, for example from 30 ppm to about 10 wt % in the agricultural composition.

Relative to the total weight of components (a), (b) and (c), the content of the geraniol-based compound may be, for example, from about 2 wt % to about 50 wt %, specifically about 2 wt % to about 20 wt %, and more specifically about 2 wt % % to about 10 wt %.

Examples of suppliers for geraniol and geraniol carboxylate include, but are not limited to, BASF, VWR, Selleck Chemicals (Houston, TX), Guangzhou Baihua Flavors and Fragrances Company (Guangdong, China).

In addition to the geraniol-based compound, the essential oil component may further include one or more essential oils selected from cinnamon oil, garlic oil, ginger oil, clove oil, lavender oil, oregano oil, tea tree oil, fennel oil, thyme oil and rosemary oil; and specifically ginger oil, clove oil and thyme oil. Preferably, the geraniol-based compound comprises at least 40 wt %, specifically at least 50 wt %, more specifically at least 80 wt % and even more specifically at least 90 wt % of the essential oil component.

In an exemplary embodiment, the concentrate or undiluted agricultural composition comprises about 2 wt % to about 5 wt % geraniol-based compound and about 2 wt % to about 5 wt % ginger oil. In another exemplary embodiment, the concentrate or undiluted agricultural composition comprises about 2 wt % to about 5 wt % geraniol-based compound, about 1 wt % to about 5 wt % clove oil, and about 1 wt % to about 5 wt % thyme oil. In yet another embodiment, the essential oil component of the agricultural composition may comprise only the geraniol-based compound.

### (b) Polysiloxane

The polysiloxane has a structure of general formula (I):

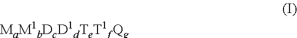

wherein
M=R¹R²R³SiO_{1/2}
M¹=R⁴R⁵R⁶SiO_{1/2}
D=R⁷R⁸SiO_{2/2}
D¹=R⁹R¹⁰SiO_{2/2}
T=R¹¹SiO_{3/2}
T¹=R¹²SiO_{3/2}
Q=SiO_{4/2}
in which
R¹, R², R³, R⁴, R⁵, R⁷, R⁸, R⁹ and R¹¹ each independently is selected from an alkyl group of 1 to about 6 carbon atoms and an aryl group of about 6 to about 14 carbon atoms; and specifically from an alkyl group of 1 to about 4 carbon atoms such as methyl, and an aryl group of about 6 to about 12 carbon atoms, for example 6 to about 10 carbon atoms, such as phenyl;
R⁶, R¹⁰ and R¹² each independently is selected from a hydroxyl and an alkoxy group of 1-4 carbon atoms, such as methoxy, ethoxy, n-propoxy and isopropoxy, and in particular at least one of R⁶, R¹⁰ and R¹² is hydroxyl;
subscripts a and b each independently is from 0 to about 22, specifically 0 to about 10, more specifically 0 to about 6; subscripts c and d each independently is from 0 to about 50, specifically about 2 to 30, more specifically about 3 to about 20; and subscripts e, f and g each independently is from 0 to about 10, specifically 0 to about 5, more specifically 0 to about 2; with the proviso that a+b is about 2 to about 22, specifically 2 to about 10, more specifically 2 to about 6, b+d+f is at least about 1, specifically at least about 2, and e+f+g is up to about 10, specifically up to about 5, more specifically up to about 3.

In an embodiment, the subscript b is from about 1 to about 10, for example, from about 2 to about 5; and at least one, for example, at least two, three or four, preferably all of R⁶ are hydroxyl.

In another embodiment, the subscript d+f>0; and at least one, specifically at least two, more specifically at least three, even more specifically all of R¹⁰ and R¹² are alkoxy groups of 1-4 carbon atoms, such as methoxy and ethoxy.

In yet another embodiment, the subscripts d, e, f and g are zero. In particular, a is 0 or about 1 and b is about 1 or about 2, with the proviso that: a+b is about 2; and preferably b is about 2. The subscript c is about 2 to about 50, preferably about 2 to 30, and more preferably about 3 to about 20.

In a preferred embodiment, the polysiloxane has the structure: M¹D_{c}M¹, wherein M¹ and D are as defined above; and c is about 2 to about 50, preferably about 2 to 30, more preferably about 3 to about 20. In a particular embodiment, at least one of R⁶ is hydroxyl, and more particularly both R⁶ are hydroxyl groups.

The polysiloxane used according to the present invention is typically a fluid at room temperature, and has a viscosity measured by a Brookfield viscometer at 25° C. of 50 cps or less, specifically 30 cps or less, such as 20 cps or less. The polysiloxane typically has a number average molecular weight of 2000 or less, such as 1000 or less.

The polysiloxane of general formula (I), in particular those having a terminal hydroxyl group, can improve deposition and adhesion of agricultural compositions, especially spray formulations, on foliar surfaces. Improved deposition and adhesion on foliar surfaces may be characterized by reduced dynamic surface tension (DST). Dynamic surface tension plays a key role in whether or not a spray droplet adheres to a foliar surface or bounces off (see Stevens et al., 1993, Pestic. Sci., 38, 237-245, which is incorporated herein by reference in its entirety). Therefore, spray formulations having reduced dynamic surface tension favor better droplet adhesion.

The polysiloxane fluids used in the present invention are commercially available under a variety of trade names, examples of which include, but are not limited to, F73GE and SF99 from Momentive Performance Materials Inc., PMX from Dow, Modified Silicones from Shin-Etsu Silicone of America Inc., Functional Silicone Fluids from Wacker, and SiSiB® fluids from NANJING SiSiB SILICONES CO., LTD.

The polysiloxane may be present in an amount of about 10 ppm to about 50 wt %, preferably about 20 ppm to about 20 wt % in the agricultural composition.

### (c) Nonionic Surfactant

The nonionic surfactant comprises at least one selected from a blocked or random polyoxyethylene/polyoxypropylene copolymer and a fatty alcohol alkoxylate.

The blocked or random polyoxyethylene/polyoxypropylene copolymer may have general formula (II):

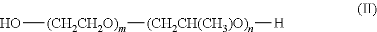

in which m is about 10 to about 50, specifically 15 to 40; and n is about 1 to about 50, specifically about 5 to about 40; with the proviso that m is at least about 10%, specifically about 20% to about 80% of m+n.

The commercial examples of the blocked or random polyoxyethylene/polyoxypropylene copolymers include Pluronics series from BASF.

The fatty alcohol alkoxylate may have a structure of general formula (III):

RO—(C₂H₄O)ₓ—(C₃H₆O)_{y}—R′ (III)

in which RO— represents a residue of a C4-C18, preferably C8-C13 linear or branched fatty alcohol; R′ represents hydrogen or a capped hydrocarbon group such as an alkyl group having 1 to about 4 carbon atoms; x is generally 2 to 8, specifically 3 to 7, such as 3, 3.5, 4, 5, 6 or 7; y is generally 0 to 6, specifically 0 to 4, such as 0, 1, 2, 3 or 4.

In an embodiment, “RO—” in general formula (III) has a structure of general formula (IV):

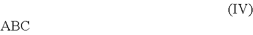

in which
A is methyl,
B is a linear or branched hydrocarbon group having about 4 to 9 carbon atoms,
C is —C(R¹³)(R¹⁴)—O—, wherein R¹³ and R¹⁴ are each independently selected from hydrogen, methyl and a linear or branched alkyl group having 2 to 5 carbon atoms, with the proviso that: the total number of carbon atoms of A, B and C is about 4 to 18, specifically about 8 to 13, and the number of carbon atoms of A and B is about 5 to 10.

The commercial examples of the fatty alcohol alkoxylate include: isodecyl alcohol ethoxylates such as RHODASURF DA 530 from Solvay and Cerewin ID-40 from Sasol Chemicals; 2-ethyl hexyl alcohol alkoxylates such as Ecosurf™ series from Dow; branched alcohol alkoxylates such as Tergitol TMN-3, TMN-6, TMN-10, and Tergitol 15-S series, and 15 S-3, 15S-5, 15-S-7, 15-S-9 from Dow; and guerbet alcohol alkoxylates, such as Lutensol XL series from BASF and Novel G12 series from Sasol.

In addition to the blocked or random polyoxyethylene/polyoxypropylene copolymer and the fatty alcohol alkoxylate, the essential oil-based composition of the present invention may further contain an additional nonionic surfactant, for example, alkyl acetylenic diols, such as SURFONYL-Evonik (Allentown, PA).

In the agricultural composition of the present invention, the content of the geraniol-based compound is about 2-50 parts by weight, preferably about 3-30 parts by weight, the content of the polysiloxane of general formula (I) is about 5-50 parts by weight, preferably about 8-30 parts by weight, and the content of the nonionic surfactant is about 30-90 parts by weight, preferably 50-85 parts by weight, and the content of water when present is about 2-2000 parts by weight, based on 100 parts by weight of the total of the components (a), (b) and (c).

The agricultural composition of the present invention may be used either as a tank-mix or in-can, preferably as a tank-mix. The term “tank-mix” as used herein means the combination of at least one agrochemical with a spray medium, such as water or oil, at the point of use. The term “in-can” as used herein refers to a formulation or concentrate containing at least one agrochemical. The “in-can” formulation may then be diluted to the application concentration at the point of use, or it may be used undiluted.

The composition may further comprises one or more selected from the group consisting of herbicides, insecticides, growth regulators, fungicides, bactericides, acaricides, fertilizers, biologicals, plant nutritionals, micronutrients, biocides, foam control agents, wetting agents, spreading agents, dispersants, and adhesion and deposition aids. Specific examples of herbicidal and plant growth regulators include, but are not limited to: phenoxy acetic acids, phenoxy propionic acids, phenoxy butyric acids, benzoic acids, triazines and s-triazines, substituted ureas, uracils, bentazon, desmedipham, methazole, phenmedipham, pyridate, amitrole, clomazone, fluridone, norflurazone, dinitroanilines, isopropalin, oryzalin, pendimethalin, prodiamine, trifluralin, glyphosate, sulfonylureas, imidazolinones, clethodim, diclofop-methyl, fenoxaprop-ethyl, fluazifop-p-butyl, haloxyfop-methyl, quizalofop, sethoxydim, dichlobenil, isoxaben, bipyridylium compounds, and the like. Fertilizers or micronutrients include, but are not limited to, zinc sulfate, ferrous sulfate, ammonium sulfate, urea, urea ammonium nitrogen, ammonium thiosulfate, potassium sulfate, monoammonium phosphate, urea phosphate, calcium nitrate, boric acid, potassium and sodium salts of boric acid, phosphoric acid, magnesium hydroxide, manganese carbonate, calcium polysulfide, copper sulfate, manganese sulfate, iron sulfate, calcium sulfate, sodium molybdate, and calcium chloride.

In another aspect, the present invention provides a method for preparing the agricultural composition of the present invention, which comprises blending the essential oil component (a), the polysiloxane (b) of general formula (I) and the nonionic surfactant (c) optionally in the presence of water. Typically, the composition of the present invention may be obtained in a form of a concentrate by blending the essential oil component (a), the polysiloxane (b) of the general formula (I) and the nonionic surfactant (c) in the presence of water which is in an amount of up to 50 parts by weight, for example up to 30 parts by weight, specifically up to 10 parts by weight relative to 100 parts by weight of the total weight of the components (a), (b) and (c). The composition may be diluted, for example, with water, to a desired concentration, by for example, 100 to about 3000 times, such as about 300 to about 2000 times before being applied to plants or soils.

In yet another aspect, the present invention provides a method for controlling a pest, which comprises applying the agricultural composition of the present invention to a soil or a plant. The essential oil-based agricultural composition according to the present invention is effective in controlling pests, especially plant pathogens such as fungal plant pathogens and harmful insects. The fungal plant pathogens include, but are not limited to, genus of Botrytis, Passalora, Phytophthora and Corynespora; specifically Botrytis cinerea, Passalora fulva, Phytophthora infestans and Corynespora cassiicola, and more specifically Botrytis cinerea. The harmful insects include, but are not limited to, whiteflies and aphids.

The agricultural composition according to the present invention may further be added with, before application, for example, one or more selected from the group consisting of herbicides, insecticides, growth regulators, fungicides, bactericides, acaricides, fertilizers, biologicals, plant nutritionals, micronutrients, biocides, foam control agents, wetting agents, spreading agents, dispersants, and adhesion and deposition aids.

In a further aspect, the present invention relates to use of geraniol or geraniol carboxylate for protecting plants, which comprises applying a formulation comprising geraniol, geraniol carboxylate or a combination thereof as an active ingredient to a plant or a soil. In a preferred embodiment of the present invention, the formulation comprising geraniol, geraniol carboxylate or a combination thereof as an active ingredient further comprises one or more agrochemical ingredients.

Suitable agrochemical ingredients include, but are not limited to, herbicides, insecticides, growth regulators, fungicides, bactericides, acaricides, fertilizers, biologicals, plant nutritional s, micronutrients, biocides, methylated seed oils, vegetable oils, foam control agents, surfactants, wetting agents, dispersants, emulsifiers, deposition aids, and anti-drift components. In an embodiment, said formulation does not contain an additional fungicide.

According to the present invention, geraniol or geraniol carboxylate can be used to control a variety of fungal plant pathogen, including genus of Botrytis, Passalora, Phytophthora and Corynespora; specifically Botrytis cinerea, Passalora fulva, Phytophthora infestans and Corynespora cassiicola, and more specifically Botrytis cinerea. Botrytis cinerea tends to infect grapes, tomatoes and strawberries to cause gray mold. Passalora fulva tends to infect tomatoes, eggplants and peppers to cause leaf mold. Phytophthora infestans tends to infect tomatoes, potatoes, eggplants and peppers to cause late blight. Corynespora cassiicola tends to infect cucumbers, gourds, papayas, tomatoes, peppers and legume crops to cause target spot disease.

Thus, geraniol or geraniol carboxylate can also be used to protect plants, especially the above crops, against diseases caused by said fungal plant pathogens, in particular grey mold, leaf mold, late blight and target spot diseases.

### EXAMPLES

The following Examples are provided to illustrate preferable embodiments of the present invention. These Examples are provided for purposes of illustration only and should not be construed as limiting. In addition, all contents are based on weight, unless otherwise stated. Besides, all viscosities are measured at 25° C. using a Brookfield rotational viscometer, unless otherwise stated.

Table 1 provides a description of the materials used in the Examples and Comparative Examples.

TABLE 1

| Components | Description |
|---|---|
| Geraniol 60 | Geraniol from BASF |
| F73GE | Polysiloxane from Momentive Performance Materials Inc., |
| | having a structure of general formula (I) in which b |
| | is 2; c is 7; a, d, e, f and g are 0; R⁴, R⁵, R⁷ and R⁸ |
| | are methyl; and R⁶ is hydroxyl |
| Cerewin ID-40 | Surfactant of isodecyl alcohol ethoxylate from Sasol |
| | Chemicals, wherein the fatty alcohol moiety thereof |
| | is a C10-rich C9-C11 alcohol, 4 moles of oxyethylene |
| | units per molecule |
| PMDS | Polydimethylsiloxane capped with methyl and having a |
| | degree polymerization of 7, from Momentive Performance |
| | Materials Inc. |
| AgroSpred Prime | Polyether-modified heptamethyltrisiloxane, from |
| | Momentive Performance Materials Inc. |
| Saponin Nonionic | Soap Bark Extract from Xi′an Clover Biotechnology |
| Surfactant | Co., Ltd. |

### Example 1

The essential oil-based agricultural composition (hereinafter referred to as the essential oil composition for simplicity) of Example 1 was prepared by mixing Geraniol 60, F73GE, Cerewin ID-40 and water in the amounts shown in Table 2 in a 150 mL beaker at room temperature (25° C.) and stirred with a magnetic stirrer until the composition was clear and homogeneous. The resultant essential oil composition was a clear and colorless liquid having a viscosity of 20 cps at 25° C., and the pH thereof in a 1% aqueous solution was 6.5. No separation was observed for the essential oil composition after 3 freeze-thaw cycles, indicating its excellent stability.

### Comparative Example 1

Agrospred 960 (Momentive Performance Materials Inc.), a commercially available dispersible essential oil composition based on d-limonene and anionic surfactants (sulfonate and sulfate), was used as the “Comparative Benchmark”.

### Comparative Examples 2 to 8

Essential oil compositions of Comparative Examples 2 to 8 were prepared in a manner similar to Example 1 by using and mixing the components and amounts shown in Table 2, and were evaluated for their stability by visually observing the states immediately after preparation and the states after being left in an oven at 50° C. for two weeks. The results are shown in Table 2.

TABLE 2

| | Example | Comp. | Comp. | Comp. | Comp. | Comp. | Comp. | Comp. |
|---|---|---|---|---|---|---|---|---|
| | 1 | 2 | 3 | 4 | 5 | 6 | 7 | 8 |
| Geraniol | 6 | 6 | 6 | 6 | 6 | 6 | 6 | 6 |
| 60 | | | | | | | | |
| F73GE | 10 | 10 | | | | 10 | 10 | |
| PMDS | | | | 10 | 10 | | | |
| AgroSpred | | | | | | | | 10 |
| Prime | | | | | | | | |
| Cerewin | 79 | | 79 | 79 | | | | 74 |
| ID-40 | | | | | | | | |
| Saponin | | 10 | | | | | 79 | |
| Nonionic | | | | | | | | |
| Surfactant | | | | | | | | |
| Water | 5 | 74 | 15 | 5 | 84 | 84 | 5 | 10 |
| Total | 100 | 100 | 100 | 100 | 100 | 100 | 100 | 100 |
| Stability | no | formation | no | separation | separation | separation | no | no |
| at RT | separation | of turbid | separation | occurs | occurs | occurs | dispersion | separation |
| | | dispersion | | | | | formed, | |
| | | with | | | | | due to an | |
| | | many | | | | | over high | |
| | | foams | | | | | viscosity | |
| Stability at | no | — | no | obvious | obvious | obvious | — | no |
| 50° C.*⁾ | separation | | separation | separation | separation | separation | | separation |

*⁾“—” indicates that a further 50° C. storage stability test was not performed due to failure to form a suitable dispersion at room temperature.

### Example 2

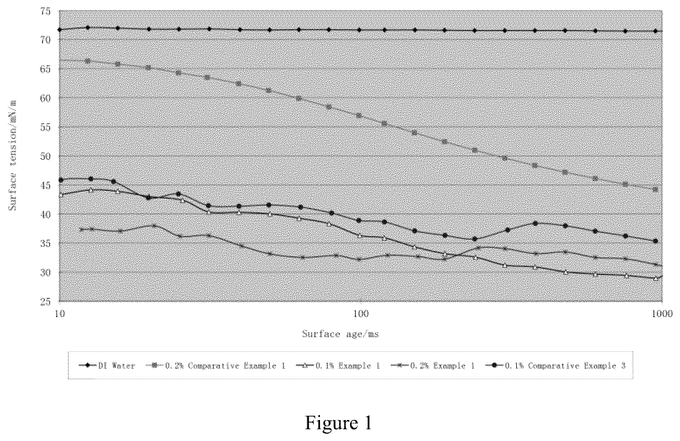

The essential oil compositions of Example 1, Comparative Example 1 and Comparative Example 3 were diluted 500 times or 1000 times in distilled water to form aqueous solutions having a concentration of 0.1 wt % or 0.2 wt %. The dynamic surface tension of these aqueous solutions were measured by the maximum bubble pressure method using a Kruss BP-100, and the results are shown in FIG. 1.

The results in FIG. 1 show that the dynamic surface tensions of the essential oil compositions of Example 1 are significantly lower than those of the compositions of Comparative Examples 1 and 3 at the same concentrations. Lower dynamic surface tension facilitates better deposition and adhesion of spray formulations to plant foliage.

### Example 3

Laboratory trials were conducted by the plate method to determine the ability of the essential oil compositions of Example 1, Comparative Example 1 and Comparative Example 8 in inhibiting the growth of fungal plant pathogens (plant diseases).

Several fungal plant pathogen were collected from vegetable greenhouses in Shouguang (Shandong Province, China), and individually inoculated into potato dextrose agar (PDA) medium at 25° C. for 5 days. The fungal plant pathogens were transferred to fresh PDA medium without (blank) and with different dosages of each essential oil composition, and incubated at 25° C. for 5-7 days. The percent inhibition was determined by measuring the diameter of the treated colony through cross method, and comparing it with that of the blank control without the essential oil composition. Statistical analysis of trial data was performed with EXCEL2016, and variance analysis was performed with SPSS21.0. Data sharing similar postscripts are not statistically significant (p<0.05).

Table 3 lists the fungal plant pathogens collected to determine the effectiveness of the essential oil compositions in inhibiting pathogens. Tables 4 to 6 list the inhibition rates of the essential oil compositions of Example 1 and Comparative Example 1 or Comparative Example 8 against the fungal plant pathogens at different concentrations (dosages).

TABLE 3
Plant pathogens used in lab trials of growth inhibition

| Pathogen | Common Name |
|---|---|
| Botrytis cinerea | grey mold |
| Passalora fulva | leaf mold |
| Phytophthora infestans | late blight |
| Corynespora cassiicola | target spot |

TABLE 4
Effect of essential oil compositions on growth inhibition
(%) of tomato grey mold (Botrytis cinerea)

| Concentration | 0.33% | 0.20% | 0.13% | 0.10% | 0.07% |
|---|---|---|---|---|---|
| Example 1 | 95.93Aa | 95.70Aa | 92.56Aa | 91.21Aa | 85.76Aa |
| Comparative | 73.14Bb | 52.10Cc | 37.21Ee | 31.82Dd | 30.68Df |
| Example 1 | | | | | |
| Comparative | 78.13Bb | 70.36Bb | 61.61Cc | 59.00Bb | 42.86BCcd |
| Example 8 | | | | | |

TABLE 5
Effect of essential oil compositions on growth inhibition
(%) of tomato leaf mold (Passalora fulva)

| Concentration | 0.33% | 0.20% | 0.13% | 0.10% | 0.07% |
|---|---|---|---|---|---|
| Example 1 | 85.36Aa | 75.60ABbc | 75.60Aa | 72.35Aa | 61.77Aa |
| Comparative | 75.75Bb | 74.49ABc | 69.21Aa | 63.28Bb | 57.53Aa |
| Example 1 | | | | | |

TABLE 6
Effect of essential oil compositions on growth inhibition
(%) of tomato late blight (Phytophthora infestans)

| Concentration | 0.33% | 0.20% | 0.13% | 0.10% | 0.07% |
|---|---|---|---|---|---|
| Example 1 | 89.94Aa | 85.48Aa | 83.63Aa | 84.00Aa | 78.05Aa |
| Comparative | 90.54Aa | 86.63Aa | 84.25Aa | 74.26Bb | 64.81Bb |
| Example 1 | | | | | |
| Comparative | 86.41Aa | 75.53Bb | 50.33Bb | 43.92Dd | 38.35CDc |
| Example 8 | | | | | |

TABLE 7
Effect of essential oil compositions on growth inhibition
(%) of cucumber target spot (Corynespora cassiicola)

| Concentration | 0.33% | 0.20% | 0.13% | 0.10% | 0.07% |
|---|---|---|---|---|---|
| Example 1 | 74.24Aa | 67.41Aa | 59.87Aa | 53.90Aab | 41.10ABab |
| Comparative | 77.31Aa | 68.04Aa | 61.59Aa | 56.92Aa | 49.07Aa |
| Example 1 | | | | | |
| Comparative | 56.78CDc | 49.67Bb | 42.29Bb | 40.78Bc | 31.63BCbc |
| Example 8 | | | | | |

Tables 4-7 demonstrate that overall, the essential oil composition of Example 1 of the present invention provides equivalent or better control of growth inhibition across the spectrum of plant pathogens relative to the commercial essential oil composition of Comparative Example 1 and the essential oil composition of Comparative Example 8 without F73GE. Moreover, for each of the fungal pathogens tested, the essential oil composition of Example 1 provided better growth inhibition effect than the essential oil composition of Comparative Example 8 without F73GE, and this difference in the growth inhibition effects, as a whole, was more pronounced at a lower concentration. This indicates that the polysiloxane of general formula (I) can significantly improve the effect in inhibiting pathogens.

In particular, the geraniol-based essential oil compositions of Example 1 and Comparative Example 8 provided significantly better inhibition of grey mold (Botrytis genus) than the commercial d-limonene-based essential oil composition of Comparative Example 1 at all concentrations. Moreover, as the concentration decreased, the inhibition effect of the essential oil composition of Comparative Example 1 decreased rapidly, whereas the inhibition effect of the essential oil compositions of Example 1 and Comparative Example 8 decreased slowly, which was about 60% or higher even at a concentration of 0.10%, indicating that geraniol has a high inhibition activity on Botrytis genus, especially Botrytis cinerea.

### Example 4: Control of Silver Whitefly (Bemisia tabaci) in Cucumber

The effect of the essential oil-based composition of the present invention on silver whitefly (Bemisia tabaci) control in cucumber was determined by applying the essential oil composition of Example 1 at various concentrations to cucumber infested with the insect. The cucumber plants were sprayed with either water, or dilute sprays containing 0.067%, 0.1% and 0.2% of the essential oil composition of Example 1. Sprays were applied to cucumber to run-off, which was between 450 L/ha (young plants) to 675 L/ha (mature), depending on growth stage during the trial.

The number of silver whitefly was counted before treatment, as well as at 4 h, 12 h and 24 h after treatment. The pest decreased rate was determined relative to the number before treatment, and the control efficiency (%) was determined relative to the water alone treatment.

TABLE 8
Effect of Essential Oil Composition on Control of
Bemisia tabaci on Cucumber

| | 4 h | | 12 h | | 24 h | |
|---|---|---|---|---|---|---|
| | Pest | Control | Pest | Control | Pest | Control |
| | Decreased | Efficiency | Decreased | Efficiency | Decreased | Efficiency |
| Treatment | Rate (%) | (%) | Rate (%) | (%) | Rate (%) | (%) |
| water | 33.72 | — | 37.47 | — | 42.19 | — |
| 0.2% | 88.72 | 81.05a | 90.88 | 83.27a | 91.6 | 82.68a |
| Example 1 | | | | | | |
| 0.1% | 80.79 | 67.72ab | 83.4 | 69.85b | 81.96 | 65.16b |
| Example 1 | | | | | | |
| 0.067% | 75.14 | 61.81b | 80.76 | 68.60b | 81.29 | 66.78b |
| Example 1 | | | | | | |

Table 8 demonstrates that the essential oil composition of Example 1 according to the present invention provided rapid pest control as well as improved control efficiency relative to the water treatment alone.

### Example 5: Control of Aphids in Cucumber

The effect of the essential oil-based composition of the present invention on aphid control in cucumber was determined by applying the essential oil composition of Example 1 at various concentrations to cucumber infested with aphids. The cucumber plants were sprayed with either water, or dilute sprays containing 0.067%, 0.1% and 0.2% of the essential oil composition of Example 1. Sprays were applied to cucumber to run-off, which was between 450 L/ha (young plants) to 675 L/ha (mature), depending on growth stage during the trial.

The number of aphids was counted before treatment, as well as at 4 h, 12 h and 24 h after treatment. The pest decreased rate was determined relative to the number before treatment, and the control efficiency (%) was determined relative to the water alone treatment.

TABLE 9
Effect of Essential Oil Composition on Aphid Control in Cucumber

| | 4 h | | 12 h | | 24 h | |
|---|---|---|---|---|---|---|
| | Pest | Control | Pest | Control | Pest | Control |
| | Decreased | Efficiency | Decreased | Efficiency | Decreased | Efficiency |
| Treatment | Rate (%) | (%) | Rate (%) | (%) | Rate (%) | (%) |
| water | 2.96 | — | 15.54 | — | 17.31 | — |
| 0.2% | 26.67 | 24.01a | 39.36 | 29.17a | 52.02 | 41.97a |
| Example 1 | | | | | | |
| 0.1% | 26.74 | 23.91a | 38.25 | 25.52a | 47.85 | 36.75a |
| Example 1 | | | | | | |
| 0.067% | 19.56 | 16.64b | 32.03 | 17.92b | 36.93 | 23.09b |
| Example 1 | | | | | | |

Table 9 demonstrates that the essential oil composition of Example 1 according to the present invention provided rapid pest control as well as improved control efficiency relative to the water treatment alone.

### Example 6

The effect of the essential oil-based composition of the present invention on control of powdery mildew in cucumber was determined by applying the essential oil composition of Example 1 at various concentrations to cucumber infected with the fungal pathogen. The cucumber plants were sprayed with either water, or dilute sprays containing 0.067%, 0.1% and 0.2% of the essential oil composition of Example 1. Sprays were applied to cucumber to run-off, which was between 450 L/ha (young plants) to 675 L/ha (mature), depending on growth stage during the trial.

The level of infection was determined before treatment, as well as at 12 h, 24 h and 48 h after treatment, and was graded as follows:
Grade 0: no scab;
Grade 1: The scab area accounts for less than 5% of the leaf area;
Grade 3: The scab area accounts for 6-10% of the leaf area;
Grade 5: The scab area accounts for 11-20% of the leaf area;
Grade 7: The scab area accounts for 21-40% of the leaf area;
Grade 9: The scab area accounts for more than 40% of the leaf area.

The disease index and control effect (%) were calculated according to the following equations and the results are shown in Table 10:

$$Disease index = [ \text{} \sum ( the number of infected leaves of each grade \times grade value ) ] \text{} / [ \text{} total number of leaves in the trial \times 9 ] \times 100$$

$$Control effect ( \% ) = [ \text{} 1 - ( disease index before water treatment \times disease index after composition treatment ) / ( disease index after water treatment \times disease index before composition treatment ) ] \times 100$$

TABLE 10
Effect of Essential Oil Compositions on Powdery Mildew in Cucumber

| | | 12 h | | 24 h | | 48 h | |
|---|---|---|---|---|---|---|---|
| | Disease index | | Control | | Control | | Control |
| | before | Disease | effect | Disease | effect | Disease | effect |
| Treatment | treatment | index | (%) | index | (%) | index | (%) |
| water | 28.09 | 28.70 | — | 29.01 | — | 31.06 | — |
| 0.2% | 20.99 | 8.02 | 61.84a | 8.33 | 61.45a | 8.02 | 65.43a |
| Example 1 | | | | | | | |
| 0.1% | 19.44 | 8.25 | 58.22a | 8.02 | 59.98a | 8.64 | 60.02a |
| Example 1 | | | | | | | |
| 0.067% | 23.77 | 20.99 | 13.40b | 20.63 | 16.56b | 22.22 | 16.65b |
| Example 1 | | | | | | | |

Table 10 demonstrates that the essential oil composition of Example 1 according to the present invention provided better control of the powdery mildew relative to the water treatment alone.

1. An essential oil-based agricultural composition, comprising:
(a) an essential oil component comprising at least one geraniol-based compound selected from geraniol, geraniol carboxylate or a combination thereof,
(b) a polysiloxane of general formula (I): 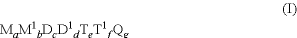
wherein
M=R¹R²R³SiO_{1/2}
M¹=R⁴R⁵R⁶SiO_{1/2}
D=R⁷R⁸SiO_{2/2}
D¹=R⁹R¹⁰SiO_{2/2}
T=R¹¹SiO_{3/2}
T¹=R¹²SiO_{3/2}
Q=SiO_{4/2}
in which
R¹, R², R³, R⁴, R⁵, R⁷, R⁸, R⁹ and R¹¹ each independently is selected from an alkyl group of 1 to about 6 carbon atoms and an aryl group of about 6 to about 14 carbon atoms,
R⁶, R¹⁰ and R¹² each independently is selected from a hydroxyl and an alkoxy group of 1-4 carbon atoms;
subscripts a and b each independently is from 0 to about 22, c and d each independently is from 0 to about 50, subscripts e, f and g each independently is from 0 to about 10, with the proviso that: a+b is about 2 to about 22; b+d+f is at least about 1 and e+f+g is up to about 10; and
(c) a nonionic surfactant comprising at least one selected from a blocked or random polyoxyethylene/polyoxypropylene copolymer and a fatty alcohol alkoxylate; and
(d) optionally, water.

2. The agricultural composition of claim 1, wherein the geraniol-based compound is present in the agricultural composition in an amount of about 10 ppm to about 50 wt %, preferably about 20 ppm to about 20 wt %.

3. The agricultural composition of claim 1, wherein in the general formula (I), at least one of R⁶, R¹⁰ and R¹² is a hydroxyl.

4. The agricultural composition of any one of claim 1, wherein b is about 1 to about 10, and at least one, preferably all of R⁶ is hydroxyl.

5. The agricultural composition of claim 1, wherein in the general formula (I), a is 0 or about 1, b is about 1 or about 2, preferably about 2, c is about 2 to about 20, and d, e, f and g are 0, with the proviso that a+b is about 2.

6. The agricultural composition of claim 1, wherein the nonionic surfactant is selected from a blocked or random polyoxyethylene/polyoxypropylene copolymer of the general formula (II): 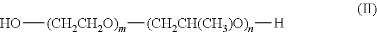
where m is about 10 to about 50 and n is about 1 to about 50 with the proviso that m is at least 10% of m+n; and
a fatty alcohol alkoxylate, where the fatty alcohol is selected from C4-C18, preferably C8-C13 linear or branched fatty alcohol; and the alkoxylate is selected from ethoxylate, propoxylate or mixture thereof, preferably ethoxylate.

7. The agricultural composition of claim 1, wherein a content of the geraniol-based compound is about 2-50 parts by weight, preferably about 3-30 parts by weight, a content of the polysiloxane of general formula (I) is about 5-50 parts by weight, preferably about 8-30 parts by weight, and a content of the nonionic surfactant is about 30-90 parts by weight, preferably 50-85 parts by weight, and the content of water when present is about 2-2000 parts by weight, based on 100 parts by weight of the total of the components (a), (b) and (c).

8. A method for preparing the agricultural composition of claim 1, which comprises blending components (a), (b) and (c) optionally in the presence of water.

9. A method for controlling a pest, which comprises applying the agricultural composition of claim 1 to a soil or a plant.

10. The method of claim 9, wherein the pest is selected from a nematodes, a gastropod, an arthropod such as an insect, a bacteria and a fungi; specifically the pest is selected from genus of Botrytis, Passalora, Phytophthora and Corynespora; more specifically the pest is selected from Botrytis cinerea, Passalora fulva, Phytophthora infestans and Corynespora cassiicola.

11. A method for controlling a pest which comprises applying a formulation containing geraniol, geraniol carboxylate or a combination thereof as an active ingredient to a plant or a soil, wherein the pest is selected from genus of Botrytis, Passalora, Phytophthora and Corynespora; more specifically the pest is selected from Botrytis cinerea, Passalora fulva, Phytophthora infestans and Corynespora cassiicola.

12. A method for protecting a plant from grey mold, leaf mold, late blight and target spot diseases, which comprises applying a formulation containing geraniol, geraniol carboxylate or a combination thereof as an active ingredient to a plant or a soil.

13. The method of claim 11, wherein the formulation is free of another active ingredient.

14. The method of claim 12, wherein the formulation is free of another active ingredient.
